(19) United States
(12) Patent Application Publication
(10) Pub. No.: US 2017/0038626 A1
(43) Pub. Date: Feb. 9, 2017

(54) BLIND-TYPE LIQUID CRYSTAL DISPLAY

(71) Applicant: SAMSUNG DISPLAY CO., LTD., Yongin-si (KR)

(72) Inventors: Jae Cheol PARK, Hwaseong-si (KR); Dae Ho SONG, Hwaseong-si (KR); Seong Gyu KWON, Suwon-si (KR); Sang Il KIM, Yongin-si (KR)

(21) Appl. No.: 15/019,818

(22) Filed: Feb. 9, 2016

(30) Foreign Application Priority Data
Aug. 3, 2015 (KR) 10-2015-0109554

(51) Int. Cl. G02F 1/1333; E06B 9/28; G02F 1/1345; E06B 9/36; E06B 9/38; G02F 1/133

(52) U.S. Cl. CPC G02F 1/13336; E06B 9/38; G02F 1/133377; G02F 1/13306; G02F 1/13452; E06B 9/36; E06B 9/28

(57) ABSTRACT

An exemplary embodiment of the present disclosure provides a blind-type liquid crystal display, including: a fixing member; two or more connecting members branched from the fixing member; and a plurality of liquid crystal panels that are connected to the fixing member through the connecting members and are disposed to extend in one direction, wherein each of the plurality of liquid crystal panels may include an substrate, a roof layer facing the insulation substrate, and a liquid crystal layer that is disposed between the insulation substrate and the roof layer and includes a plurality of microcavities.

### CROSS-REFERENCE TO RELATED APPLICATION

This application claims priority to and the benefit of Korean Patent Application No. 10-2015-0109554 filed in the Korean Intellectual Property Office on Aug. 3, 2015, the disclosure of which is incorporated herein by reference in its entirety.

### BACKGROUND

(a) Field

The present disclosure relates to a liquid crystal display, and more particularly, to a blind-type liquid crystal display that is capable of expanding applicability of a liquid crystal display.

(b) Description of the Related Art

A liquid crystal display, one of the most widely used flat panel displays, includes two display panels, on which field generating electrodes such as a pixel electrode and a common electrode are formed, and a liquid crystal layer interposed between the two display panels.

A liquid crystal display generates an electric field in the liquid crystal layer by applying a voltage to the field generating electrodes to determine orientations of liquid crystal molecules of the liquid crystal layer and control polarization of incident light, thereby displaying an image.

As society has become more information oriented, the demand for various types of display devices has increased. Accordingly, various kinds of display devices such as a liquid crystal display (LCD), a plasma display panel (PDP), and an electro luminescent display (ELD) have recently been developed and widely used as display devices.

Further, a technique for manufacturing a display by forming a plurality of microcavities and filling in the microcavities with liquid crystal (or nano crystal) molecules has been developed. This technique includes forming a sacrificial layer of organic materials and the like, forming a roof layer on the sacrificial layer and then removing the sacrificial layer, and filling liquid crystal molecules through liquid crystal injection holes into an empty space formed by removing the sacrificial layer.

So far, display devices have been mainly applied to television and computer monitors. However, more and more display devices are expected to be used in other applications in addition to television and computer monitors.

The above information disclosed in this Background section is only to enhance the understanding of the background of the present disclosure and therefore it may contain information that may not form a prior art that is already known to a person of ordinary skill in the art.

### SUMMARY

The present disclosure provides a blind-type liquid crystal display that is capable of expanding the applicability of a liquid crystal display.

An exemplary embodiment of the present disclosure provides a blind-type liquid crystal display, including: a fixing member; two or more connecting members branched from the fixing member; and a plurality of liquid crystal panels that are connected to the fixing member through the connecting members and are disposed to extend in one direction, wherein each of the plurality of liquid crystal panels may include an substrate, a roof layer facing the substrate, and a liquid crystal layer that is disposed between the insulation substrate and the roof layer and includes a plurality of microcavities.

Each of the two or more connecting members may include a signal cable transmitting at least one selected from a data signal, a control signal, and a power signal to an image display drive on each of the plurality of liquid crystal panels.

Each of the plurality of liquid crystal panels may be disposed to extend in a horizontal direction, and adjacent liquid crystal panels may be connected to each other through at least one of the two or more connecting members.

Each of the two or more connecting members may include a first connecting member and a second connecting member that are vertically branched from a first side and a second side of the fixing member.

The first connecting member and the second connecting member may respectively connect the plurality of liquid crystal panels at one side and another side.

The blind-type liquid crystal display may further include a driver that is disposed in the fixing member and configured to control operation of the plurality of liquid crystal panels, and two or more controlling wires vertically branched from the driver to connect the plurality of liquid crystal panels.

An angle of each of the liquid crystal panels may be controlled through the connecting member and the two or more controlling wires by rotating the driver, or a lifting or lowering operation of the plurality of liquid crystal panels may be controlled through the two or more connecting members and the two or more controlling wires by rotating the driver.

Each of the plurality of liquid crystal panels may be formed to vertically extend and may be connected to the two or more connecting members branched from the fixing member.

Each of the two or more connecting members may be branched at a predetermined distance from the fixing member and may correspond to each of the plurality of liquid crystal panels.

The blind-type liquid crystal display may further include a driver that is disposed in the fixing member and configured to control operation of the plurality of liquid crystal panels, and a plurality of controlling wires vertically branched from the driver to respectively connect the plurality of liquid crystal panels.

An angle of each of the liquid crystal panels may be controlled through the two or more connecting members and the plurality of controlling wires by rotating the driver, or a left or right movement of the plurality of liquid crystal panels may be controlled through the two or more connecting members and the plurality of controlling wires by rotating the driver.

Each of the plurality of liquid crystal panels may have a flexible substrate that is bent or curved by an external force.

Each of the plurality of liquid crystal panels may use an external light as a light source.

According to the embodiment of the present disclosure, it is possible to provide a blind-type liquid crystal display that is capable of expanding the applicability of liquid crystal displays.

### BRIEF DESCRIPTION OF THE DRAWINGS

FIG. 1 illustrates a layout view of the arrangement of signal lines and pixels of a liquid crystal display, according to an exemplary embodiment of the present disclosure.

FIG. 2 illustrates a layout view of some pixels of a liquid crystal display, according to an exemplary embodiment of the present disclosure.

FIG. 3 illustrates a cross-sectional view of the liquid crystal display of FIG. 2 taken along line

FIG. 4 illustrates a schematic diagram of a blind-type liquid crystal display, according to an exemplary embodiment of the present disclosure.

FIG. 5 illustrates a schematic diagram of another blind-type liquid crystal display configured differently from the blind-type liquid crystal display of FIG. 4.

FIG. 6 illustrates a schematic diagram of a further blind-type liquid crystal display configured differently from the blind-type liquid crystal display of FIG. 4.

FIG. 7 illustrates a schematic diagram of a blind-type liquid crystal display, according to another exemplary embodiment of the present disclosure.

### DETAILED DESCRIPTION OF THE EMBODIMENTS

The present disclosure will be described more fully hereinafter with reference to the accompanying drawings, in which exemplary embodiments of the present disclosure are shown. As those skilled in the art would realize, the described embodiments may be modified in various different ways, without departing from the spirit or scope of the present disclosure.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or one or more intervening elements may be present. In contrast, when an element is referred to as being “directly on” another element, there may be no intervening elements present.

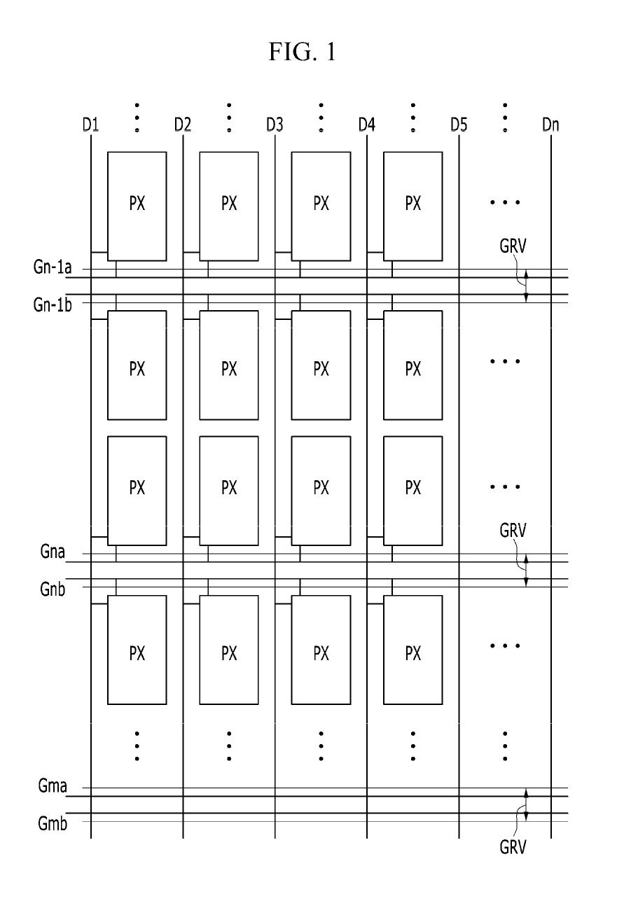

A liquid crystal display, according to an exemplary embodiment of the present disclosure, will now be described with reference to FIG. 1. FIG. 1 illustrates a layout view of the arrangement of signal lines and pixels of a liquid crystal display, according to an exemplary embodiment of the present disclosure.

Referring to FIG. 1, a liquid crystal display includes a plurality of gate lines Gn−1a, Gn−1b, Gna, Gnb, . . . , Gma, and Gmb that extend in a first direction, a plurality of data lines D1, D2, D3, D4, D5, . . . , and Dn that extend in a second direction, and a plurality of pixels PX connected to the gate lines and the data lines. The plurality of gate lines Gn−1a, Gn−1b, Gna, Gnb, Gma, and Gmb include a first pair of gate lines Gn−1a and Gn−1b, a second pair of gate lines Gna and Gnb, and a third pair of gate lines Gn+1a and Gn+1b. The respective pairs of gate lines Gn−1a and Gn−1b, Gna and Gnb, and Gn+1a and Gn+1b are positioned between two adjacent pixel rows.

In the liquid crystal display, grooves GRV are formed at positions where the respective pairs of gate lines Gn−1a and Gn−1b, Gna and Gnb, and Gn+1a and Gn+1b overlap. Each groove GRV defines a liquid crystal injection hole into which liquid crystal molecules are injected. The injection process of the liquid crystal molecules will be described below in detail.

The grooves GRV extend in the first direction in which the gate lines Gn−1a, Gn−1b, Gna, Gnb, Gma, and Gmb extend. Since the grooves GRV are formed to overlap the respective pairs of gate lines Gn−1a and Gn−1b, Gna and Gnb, and Gn+1a and Gn+1b, instead of being formed at a position overlapping only one gate line, the grooves GRV may have a large width without deteriorating an aperture ratio of the liquid crystal display.

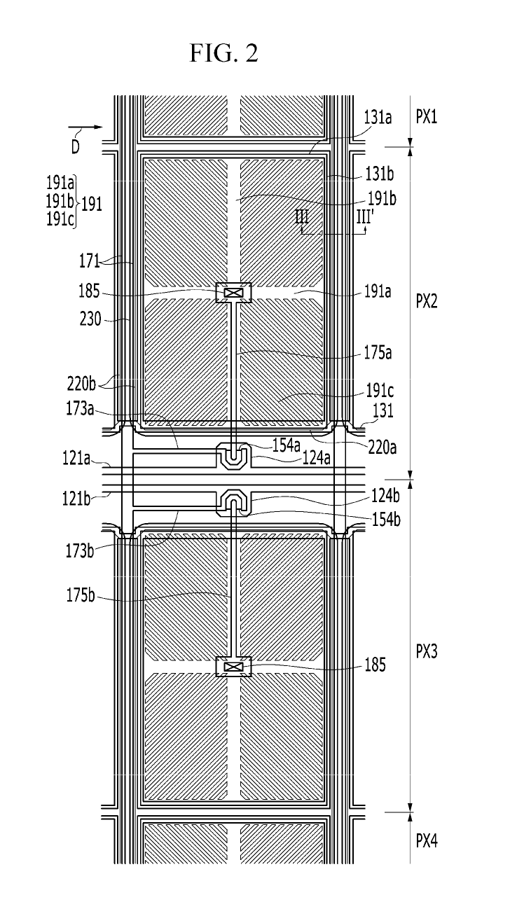

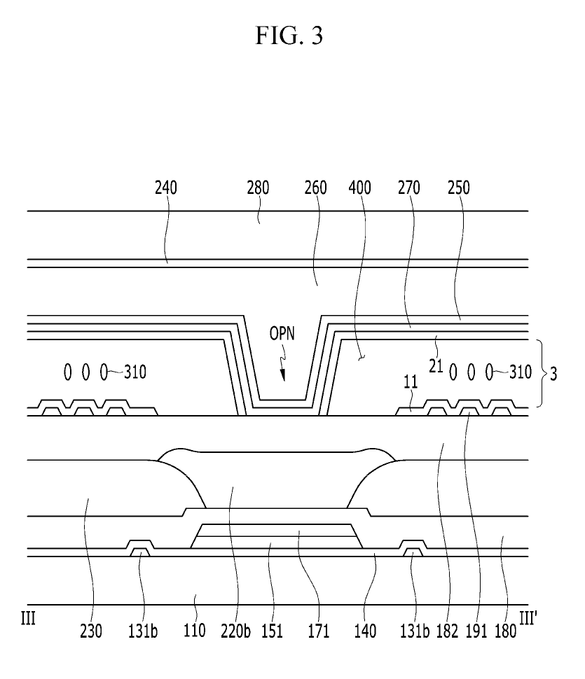

FIG. 2 illustrates a layout view of some pixels of a liquid crystal display, according to an exemplary embodiment of the present disclosure, and FIG. 3 illustrates a cross-sectional view of the liquid crystal display of FIG. 2 taken along line III-III′.

Referring to FIGS. 2 and 3, a first gate line 121a, a second gate line 121b, and a storage electrode line 131 are disposed on a substrate 110 made of transparent glass, plastic, or the like. The first gate line 121a and the second gate line 121b form a pair to be disposed between two pairs of pixels PX1 and PX2, and PX3 and PX4. The first gate line 121a and the second gate line 121b transmit a gate signal and mainly extend in a horizontal direction, the first gate line 121a includes a first gate electrode 124a, and the second gate line 121b includes a second gate electrode 124b. The storage electrode line 131 transmits a predetermined voltage, such as a common voltage Vcom, and includes vertical portions 131b that extend to be substantially perpendicular to the first gate line 121a and the second gate line 121b, and a horizontal portion 131a that connects ends of the vertical portions 131b to each other.

A gate insulating layer 140 is disposed on the first gate line 121a, the second gate line 121b, and the storage electrode line 131. A semiconductor layer 151 and a data line 171 are disposed on the gate insulating layer 140. The data line 171 transmits a data signal and mainly extends in a vertical direction to cross the first and second gate lines 121a and 121b. The data line 171 is connected with a first source electrode 173a that extends toward the first gate electrode 124a, and a second source electrode 173b that extends toward the second gate electrode 124b. The first drain electrode 175a and the second drain electrode 175b are separated from the data line 171. The first drain electrode 175a faces the first source electrode 173a on the first gate electrode 124a, and the second drain electrode 175b faces the second source electrode 173b on the second gate electrode 124b.

In the illustrated exemplary embodiment, the first drain electrode 175a and the second drain electrode 175b include rod portions that extend in a direction parallel to the data line 171. The drain electrodes 175a and 175b may have extending portions, and areas of the extending portions increase at ends of the rod portions of the first and second drain electrodes 175a and 175b. The term “the rod portion” simply refers to shapes of the drain electrodes 175a and 175b according to an exemplary embodiment, and the present disclosure is not limited to the first and second drain electrodes 175a and 175b having rod shapes.

A thin film transistor formed of the first gate electrode 124a connected to the first gate line 121a, the first source electrode 173a, the first drain electrode 175a, and a first semiconductor layer 154a is connected to a pixel electrode 191 of a second pixel PX2. Similarly, a thin film transistor formed of the second gate electrode 124b connected to the second gate line 121b, the second source electrode 173b, the second drain electrode 175b, and a second semiconductor layer 154b is connected to a pixel electrode 191 of a third pixel PX3.

The semiconductor layers 151, 154a, and 154b may have substantially the same planar shape as the data conductors 171, 173a, 173b, 175a, and 175b and an ohmic contact (not shown) therebelow, except for channel regions between the source electrodes 173a and 173b and the drain electrodes 175a and 175b. A data wire layer including the data line 171, the source electrodes 173a and 173b, and the drain electrodes 175a and 175b may be simultaneously formed with the ohmic contact disposed therebelow and the semiconductor layers 151, 154a, and 154b by using one mask. The first semiconductor layer 154a and the second semiconductor layer 154b have exposed portions that are not covered by the source electrodes 173a and 173b and 171b and the drain electrodes 175a and 175b, between the source electrodes 173a and 173b, and the drain electrodes 175a and 175b.

A passivation layer 180 is disposed on the data wire layers 171, 173a, 173b, 175a, and 175b and the exposed portions of the first semiconductor layer 154a and the second semiconductor layer 154b. The passivation layer 180 may be made of an inorganic insulating material such as a silicon nitride and a silicon oxide. In other examples, the passivation layer 180 may be made of an organic insulating material and a surface of the passivation layer 180 may be flat.

An organic layer 230 is disposed on the passivation layer 180. The organic layer 230 is positioned in most of the regions on the passivation layer 180, except where the thin film transistor and the like are disposed. In the exemplary embodiment, the organic layer 230 may extend in a column direction of the pixel electrode 191. The organic layer 230 may be a color filter, and the color filter may display one of three primary colors, red, green, and blue. However, the color is not limited to the three primary colors of red, green and blue, and the color filter may display one of cyan, magenta, yellow, and white-based colors.

The organic layers 230 that are adjacent to each other may be spaced apart from each other in a horizontal direction D as illustrated in FIG. 2 and a vertical direction crossing the horizontal direction D. FIG. 3 illustrates the organic layers 230 that are spaced apart from each other in the horizontal direction D. Referring to FIG. 2, a horizontal light blocking member 220a is disposed along the horizontal direction D, and is disposed covering the first gate line 121a and the second gate line 121b.

Referring to FIG. 3, a vertical light-blocking member 220b is disposed between the organic layers 230 that are spaced apart from each other in the horizontal direction D. The vertical light-blocking member 220b overlaps an edge of each of the adjacent organic layers 230, and the widths at which the vertical light blocking member 220b overlaps opposite edges of the organic layers 230 are substantially the same. The vertical-light-blocking member 220b may be referred to as a black matrix, and prevent light leakage. The vertical-light-blocking member 220b may be omitted, and in this case, the data line 171 may serve as the light-blocking member.

A planarization layer 182 may be disposed on the vertical-light-blocking member 220b and the organic layer 230. The planarization layer 182 may be made of an organic material and may flatten the layers formed therebelow.

The pixel electrode 191 is disposed on the planarization layer 182. The pixel electrode 191 is electrically connected to the drain electrodes 175a and 175b as one terminal of the thin film transistor through a contact hole 185. Specifically, the pixel electrode 191 of the second pixel PX2 is connected to the first drain electrode 175a, and the pixel electrode 191 of the third pixel PX3 is connected to the second drain electrode 175b.

Referring to FIG. 2, each pixel electrode 191 may be formed as a minute slit electrode. For example, the shape of the minute slit electrode is a quadrangle and includes a cross-shaped stem that is configured of a horizontal stem 191a and a vertical stem 191b crossing the horizontal stem 191a.

In addition, the pixel electrode is divided into four subregions by the horizontal stem 191a and the vertical stem 191b, and each subregion includes a plurality of minute branches 191c. The first minute branches 191c of the minute slit electrode obliquely extends to the upper left from the horizontal stem 191a or the vertical stem 191b, and the second minute branch 191c obliquely extends to the upper right from the horizontal stem 191a or the vertical stem 191b. Further, the third minute branch 191c extends to the lower left from the horizontal stem 191a or the vertical stem 191b, and the fourth minute branch 191c obliquely extends to the lower right from the horizontal stem 191a or the vertical stem 191b. The minute branches 191c of two adjacent subregions may be perpendicular to each other. Although not illustrated, a width of the minute branch 191c may gradually become wide.

The rod portions of the aforementioned drain electrodes 175a and 175b extend along the vertical stem 181b of the pixel electrode 191.

In the present exemplary embodiment, the contact hole 185 is formed to pass through the passivation layer 180, the organic layer 230, and the planarization layer 182, and the drain electrodes 175a and 175b and the pixel electrode 191 are connected to each other through the contact hole 185. In the present exemplary embodiment, the contact hole 185 may be formed at a position at which the horizontal stem 191a and the vertical stem 191b of the pixel electrode 191 cross. As shown in FIG. 2, the wide ends of the drain electrodes 175a and 175b overlap the position at which the horizontal stem 191a and the vertical stem 191b cross, and the contact hole 185 is formed at this position.

In the subregions adjacent to each other, directions in which liquid crystal molecules are inclined may be different from each other. The horizontal stem 191a and the vertical stem 191b correspond to a boundary region where the adjacent subregions meet with each other, and the boundary region corresponds to a non-transmitting portion where the inclination direction of the liquid crystal molecules is not determined. Accordingly, in the exemplary embodiment of the present disclosure, although the drain electrodes 175a and 175b and the contact hole 185 are formed within the pixel area PX, the aperture ratio may not be compromised.

A lower alignment layer 11 may be disposed on the pixel electrode 191, and an upper alignment layer 21 may be disposed facing the lower alignment layer 11. A microcavity layer 400 including a plurality of microcavities is disposed between the lower alignment layer 11 and the upper alignment layer 21. A liquid crystal layer 3 includes the microcavity layer 400. A liquid crystal material that includes the liquid crystal molecules 310 is injected in the microcavity layer 400 through liquid crystal injection holes (not shown). The microcavities in the microcavity layer 400 may be formed along the column direction of the pixel electrode 191, i.e., the vertical direction. Although not illustrated in FIG. 3, the lower alignment layer 11 and the upper alignment layer 21 may be connected to each other in a lateral surface of the liquid crystal display.

In the present exemplary embodiment, an alignment material forming the alignment layers 11 and 21 and a liquid crystal material including the liquid crystal molecules 310 may be injected into microcavities in the microcavity layer 400 by using a capillary force.

A contmon electrode 270 and an overcoat 250 are disposed on the upper alignment layer 21. The common electrode 270 receives a common voltage and generates an electric field together with the pixel electrode 191 that is applied with a data voltage to determine the inclination direction of the liquid crystal molecules 310 positioned in the microcavity layer 400 between the common electrode 270 and the pixel electrode 191. The common electrode 270 may form a capacitor along with the pixel electrode 191 such that the applied voltage is maintained after the thin film transistor is turned off. The overcoat 250 may be made of a silicon nitride (SiNx) or a silicon oxide (SiO2).

A roof layer 260 is disposed on the overcoat 250. The roof layer 260 may include silicon oxycarbide (SiOC), a photoresist, or other organic materials. When the roof layer 260 includes silicon oxycarbide (SiOC), the roof layer 260 may be formed by a chemical vapor deposition method. When including a photoresist, the roof layer 260 may be formed by a coating method. Silicon oxycarbide (SiOC) has high transmittance and low layer stress, and may not generate a change among layers that may be formed by the chemical vapor deposition method. Accordingly, in the present exemplary embodiment, by forming the roof layer 260 of silicon oxycarbide (SiOC), light may be transmitted well and a stable layer may be formed.

A passivation layer 240 is disposed on the roof layer 260. The passivation layer 240 may be made of a silicon nitride (SiNx) or a silicon oxide (SiO2). A capping layer 280 is disposed on the passivation layer 240. The capping layer 280 contacts an upper surface and a lateral wall of the roof layer 260, and covers the liquid crystal injection holes A1 and A2 of the microcavity layer 400 exposed by the groove GRV. The capping layer 280 may be formed of a thermosetting resin, silicon oxycarbide (SiOC), or graphene.

Graphene has strong impermeability against gas, including helium and the like. Therefore, the capping layer 280 formed of graphene may serve as a capping layer covering the liquid crystal injection holes A1 and A2. Since the capping layer 280 includes a material formed of carbon bonds, the capping layer 280 prevents the liquid crystal material from being contaminated even when the material of the capping layer 280 contacts the liquid crystal material. In addition, graphene may serve to protect the liquid crystal material from external oxygen and moisture.

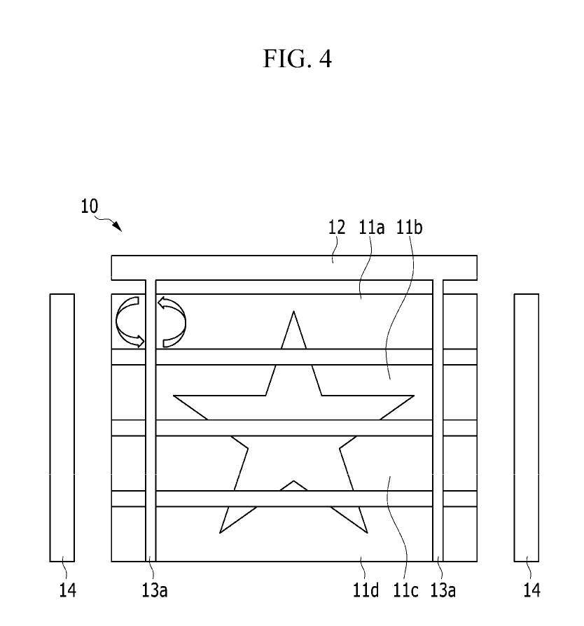

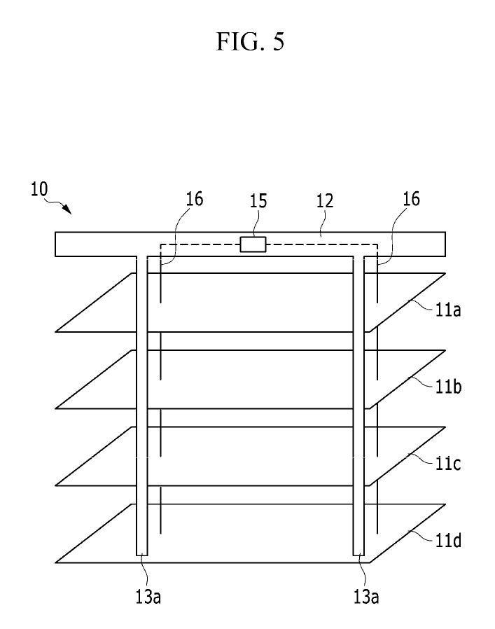

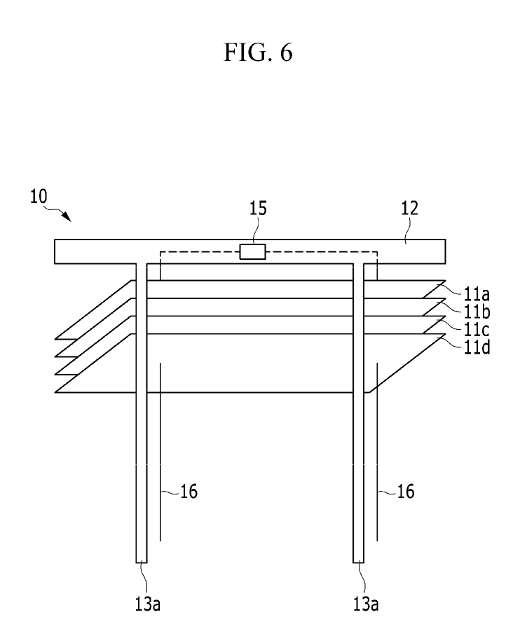

FIG. 4 illustrates a schematic diagram of a blind-type liquid crystal display, according to an exemplary embodiment of the present disclosure, and FIGS. 5 and 6 respectively illustrate a schematic diagram of another blind-type liquid crystal display configured differently from the blind-type liquid crystal display of FIG. 4. Panels of the blind-type liquid crystal displays illustrated in FIGS. 4 to 6 correspond to the liquid crystal display described with respect to FIGS. 1 to 3.

Referring to FIG. 4, a blind-type liquid crystal display 10 includes a plurality of liquid crystal panels 11a, 11b, 11c, and 11d, a fixing member 12 fixing the plurality of liquid crystal panels 11a, 11b, 11c, and 11d, and a connecting member 13a connecting the liquid crystal panels 11a, 11b, 11c, and 11d. The liquid crystal panels 11a, 11b, 11c, and 11d of the liquid crystal display 10 are respectively formed in a shape that extends in a horizontal direction.

Although not shown in FIG. 4, each of the liquid crystal panels 11a, 11b, 11c, and 11d includes a driving circuit based on the liquid crystal display described with respect to FIGS. 1 to 3. For example, a source driver (source driving circuit) outputting image data to the data line, a gate driver (gate driving circuit) switching the thin film transistor (TFT) by applying a scan signal to the gate line, etc., are configured in the liquid crystal panels 11a, 11b, 11c, and 11d. In addition, the driving circuit respectively included in the liquid crystal panels 11a, 11b, 11c, and 11d may form a non-display area in which an image is not displayed, and it may be configured in the non-display area.

The fixing member 12 may be implemented to be horizontally formed on the topmost portion of the liquid crystal panels 11a, 11b, 11c, and 11d. In this case, the fixing member 12 may include a controller that is configured to control operations of the respective liquid crystal panels 11a, 11b, 11c, and 11d, or may be connected to a separate controller.

The connecting member 13a is formed as a signal cable and connects between adjacent liquid crystal panels 11a, 11b, 11c, and 11d to transmit the image data, a control signal, and a power signal that are required for displaying image on the respective liquid crystal panels 11a, 11b, 11c, and 11d. The plurality of liquid crystal panels 11a, 11b, 11c, and 11d may respectively display the same image or divide images forming one image, depending on the image data and the control signal.

The fixing member 12 may include a connecting wire (not shown) connected to the connecting member 13a, and may connect the controller and the connecting member 13a through the connecting wire. The connecting member 13a includes a first connecting member branched from one side of the fixing member 12 and a second connecting member branched from another side of the fixing member 12.

According to one embodiment, the blind-type liquid crystal display 10 irradiates light to the liquid crystal panels 11a, 11b, 11c, and 11d using an external light source. In another embodiment, a light source 14 is disposed at a lateral surface of the blind-type liquid crystal display 10.

Referring to FIGS. 5 and 6, the plurality of liquid crystal panels 11a, 11b, 11c, and 11d may be rotated or rolled in a state as connected to the connecting member 13a. For example, the plurality of liquid crystal panels 11a, 11b, 11c, and 11d may be rotated or rolled depending on an operation of the driver 15, by installing a rotatable or rollable driver 15 in the fixing member 12 and connecting the rotatable or rollable driver 15, the connecting member 13a, and the panel controlling wire 16. As shown in FIG. 5, an angle of the plurality of liquid crystal panels 11a, 11b, 11c, and 11d may be controlled by operating the connecting member 13a and the panel controlling wire 16 depending on the rotation of the driver 15. Alternatively, as shown in FIG. 6, the plurality of liquid crystal panels 11a, 11b, 11c, and 11d may be lifted or lowered by controlling the panel controlling wire 16 to be wound or unwound depending on the rotation of the driver 15.

As described above with reference to FIGS. 1 to 3, the blind-type liquid crystal display 10 uses a single substrate and the liquid crystal panels 11a, 11b, 11c, and 11d such that the blind-type liquid crystal display 10 can be made of a light weight. The blind-type liquid crystal display 10 as shown in FIG. 4 is a horizontal blind-type liquid crystal display.

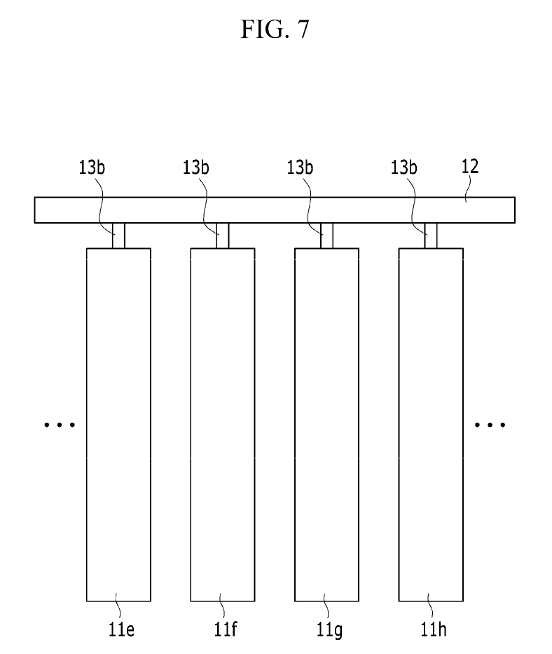

FIG. 7 illustrates a schematic diagram of a vertical blind-type liquid crystal display as another exemplary embodiment of the present disclosure. The vertical blind-type liquid crystal display 10 includes a plurality of liquid crystal panels 11e, 11f, 11g, and 11h, a fixing member 12 fixing the plurality of liquid crystal panels 11e, 11f, 11g, and 11h, and a connecting member 13b connecting the respective liquid crystal panels 11e, 11f, 11g, and 11h.

In this case, the respective liquid crystal panels 11e, 11f, 11g, and 11h are formed as vertical panels, and they are respectively connected to connecting members 13b vertically branched from the horizontal fixing member 12. Similarly to the example of the horizontal blind-type liquid crystal display 10 of FIG. 4, the connecting members 13bconnected to the respective liquid crystal panels 11e, 11f, 11g, and 11h are also formed of a signal cable.

Further, in a blind-type liquid crystal display, according to another exemplary embodiment of the present disclosure, an angle and movement of the liquid crystal panels may be controlled by a driver provided in the fixing member and a plurality of controlling wires and connecting members respectively connected to the plurality of liquid crystal panels (not shown). For example, the angle of each of the liquid crystal panels or the left or right movement of each of the liquid crystal panels may be controlled through the connecting members and the controlling wires by rotating the driver.

The examples of the blind-type liquid crystal displays disclosed herein may provide a next generation liquid crystal display having both an awning function and a display function. In addition, the blind-type liquid crystal displays can provide further weight reduction and convenience by using a flexible display device of a single substrate as a blind sheet.

While the present disclosure has been described in connection with what is presently considered to be exemplary embodiments, it is to be understood that the present disclosure is not limited to the disclosed embodiments, but, on the contrary, is intended to cover various modifications and equivalent arrangements included within the spirit and scope of the present disclosure.

<Description of symbols>

10: blind-type liquid crystal display.
11a, 11b, 11c, 11d, 11e, 11f, 11g, 11h: liquid crystal panel
12: fixing member 13a, 13b: connecting member

| | |
|---|---|
| 14: lateral light source | 15: driver |
| 16: controlling wire | 110: substrate |
| 191: pixel electrode | 230: organic layer |

220a, 220b, BM: light-blocking member 240: passivation layer
250: overcoat 260: roof layer

| | |
|---|---|
| 270: common electrode | 280: capping layer |
| 300: sacrificial layer | 310: liquid crystal molecule |
| 400: microcavity layer | |

What is claimed is:

1. A blind-type liquid crystal display, comprising:
a fixing member;
two or more connecting members branched from the fixing member; and
a plurality of liquid crystal panels that are connected to the fixing member through the connecting members and are disposed to extend in one direction,
wherein each of the plurality of liquid crystal panels comprises a substrate, a roof layer facing the substrate, and a liquid crystal layer that is disposed between the substrate and the roof layer and includes a plurality of microcavities.

2. The blind-type liquid crystal display of claim 1, wherein
each of the two or more connecting members comprises a signal cable transmitting at least one selected from a data signal, a control signal, and a power signal for displaying an image on each of the plurality of liquid crystal panels.

3. The blind-type liquid crystal display of claim 2, wherein
each of the plurality of liquid crystal panels is disposed to extend in a horizontal direction, and adjacent liquid crystal panels are connected to each other through at least one of the two or more connecting members.

4. The blind-type liquid crystal display of claim 3, wherein
each of the two or more connecting members comprises a first connecting member and a second connecting member that are vertically branched from a first side and a second side of the fixing member.

5. The blind-type liquid crystal display of claim 4, wherein
the first connecting member and the second connecting member respectively connect the plurality of liquid crystal panels at the first side and the second side.

6. The blind-type liquid crystal display of claim 5, further comprising
a driver that is disposed in the fixing member and configured to control operation of the plurality of liquid crystal panels; and
two or more controlling wires vertically branched from the driver to connect the plurality of liquid crystal panels.

7. The blind-type liquid crystal display of claim 6, wherein
an angle of each of the liquid crystal panels is controlled through the connecting member and the two or more controlling wires by rotating the driver.

8. The blind-type liquid crystal display of claim 6, wherein
a lifting or lowering operation of the plurality of liquid crystal panels is controlled through the two or more connecting members and the two or more controlling wires by rotating the driver.

9. The blind-type liquid crystal display of claim 2, wherein
each of the plurality of liquid crystal panels is formed to vertically extend and is connected to the two or more connecting members branched from the fixing member.

10. The blind-type liquid crystal display of claim 9, wherein
each of the two or more connecting members is branched at a predetermined distance from the fixing member and corresponds to each of the plurality of liquid crystal panels.

11. The blind-type liquid crystal display of claim 10, further comprising
a driver that is disposed in the fixing member and configured to control operation of the plurality of liquid crystal panels; and
a plurality of controlling wires vertically branched from the driver to respectively connect the plurality of liquid crystal panels.

12. The blind-type liquid crystal display of claim 11, wherein
an angle of each of the liquid crystal panels is controlled through the two or more connecting members and the plurality of controlling wires by rotating the driver.

13. The blind-type liquid crystal display of claim 11, wherein
a left or right movement of the plurality of liquid crystal panels is controlled through the two or more connecting member and the plurality of controlling wires by rotating the driver.

14. The blind-type liquid crystal display of claim 1, wherein
each of the plurality of liquid crystal panels has a flexible substrate that is bent or curved by an external force.

15. The blind-type liquid crystal display of claim 1, wherein
each of the plurality of liquid crystal panels uses an external light as a light source.
